(19) United States
(12) Patent Application Publication
(10) Pub. No.: US 2025/0252974 A1
(43) Pub. Date: Aug. 7, 2025

(54) ELECTRONIC DEVICE AND METHOD FOR PLAYING BACK VIDEO IN REVERSE BY SAME ELECTRONIC DEVICE

(71) Applicant: Samsung Electronics Co., Ltd., Suwon-si (KR)

(72) Inventors: Jin HEO, Suwon-si (KR); Jiyoung BANG, Suwon-si (KR); Jaehyeon JEONG, Suwon-si (KR); Wonki KIM, Suwon-si (KR); Keunha CHOI, Suwon-si (KR)

(21) Appl. No.: 19/187,035

(22) Filed: Apr. 23, 2025

Related U.S. Application Data
(63) Continuation of application No. PCT/KR2023/019438, filed on Nov. 29, 2023.

(30) Foreign Application Priority Data
Dec. 13, 2022 (KR) 10-2022-0173632
Jan. 4, 2023 (KR) 10-2023-0001063

(51) Int. Cl. G11B 27/00

(52) U.S. Cl. CPC G11B 27/005

(57) ABSTRACT

An electronic device is provided. The electronic device includes a display, at least one processor, and memory, comprising one or more storage media, storing instructions that, when executed by the at least one processor individually or collectively, cause the electronic device to, while a video is being played back in the forward direction, determine, among frames decoded to play back the video in the forward direction, a plurality of frames capable of being played back for a time required for decoding frames for reverse playback of the video in case that the video is played back in reverse, store the plurality of the determined frames in the memory, in case that the video is played back in reverse, play back the stored plurality of frames in a reverse direction, and in case that the playback of the stored plurality of frames is completed, play back, in reverse direction, the frames decoded for reverse playback of the video.

### CROSS-REFERENCE TO RELATED APPLICATION(S)

This application is a continuation application, claiming priority under 35 U.S.C. § 365(c), of an International application No. PCT/KR2023/019438, filed on Nov. 29, 2023, which is based on and claims the benefit of a Korean patent application number 10-2022-0173632, filed on Dec. 13, 2022, in the Korean Intellectual Property Office, and of a Korean patent application number 10-2023-0001063, filed on Jan. 4, 2023, in the Korean Intellectual Property Office, the disclosure of each of which is incorporated by reference herein in its entirety.

### BACKGROUND

### 1. Field

The disclosure relates to an electronic device and a method for playing back a video in reverse by the electronic device.

### 2. Description of Related Art

As the number of customers consuming short videos on various platforms increases, technology for applying various effects to short videos is also becoming more advanced.

Among the various effects, a boomerang effect of repeatedly playing back a video forward and backward is receiving positive responses from consumers, and a technical field on a method for applying the boomerang effect is also becoming more advanced.

The boomerang effect is to play back a video while sequentially outputting frames in the forward direction from frame 1 to frame N, and then play back the video while sequentially outputting the frames in the reverse direction starting from frame N to frame 1, and by repeating the forward output and reverse output of the video, the output of the video can be provided in a more interesting way.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for playing back a video in reverse by the electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a display, at least one processor, and memory, comprising one or more storage media, storing instructions. The instructions, when executed by the at least one processor individually or collectively, cause the electronic device to, while a video is being played back in the forward direction, determine, among frames decoded to play back the video in the forward direction, a plurality of frames capable of being played back for a time required for decoding frames for reverse playback of the video when the video is played back in reverse. The instructions, when executed by the at least one processor individually or collectively, cause the electronic device to store the determined plurality of frames in the memory. The instructions, when executed by the at least one processor individually or collectively, cause the electronic device to play back the stored plurality of frames in the reverse direction when playing back the video in reverse. The instructions, when executed by the at least one processor individually or collectively, cause the electronic device to, when the playback of the stored plurality of frames is completed, play back, in the reverse direction, the frames decoded for reverse playback of the video.

In accordance with another aspect of the disclosure, a method for playing back a video in reverse performed by an electronic device is provided. The method includes, while a video is being played back in the forward direction, determining, among frames decoded to play back the video in the forward direction, a plurality of frames capable of being played back for a time required for decoding frames for reverse playback of the video when the video is played back in reverse, storing the determined plurality of frames in memory of the electronic device, in case that the video is played back in reverse, playing back the stored plurality of frames in the reverse direction, and in case that the playback of the stored plurality of frames is completed, playing back, in the reverse direction, the frames decoded for reverse playback of the video.

In accordance with another aspect of the disclosure, one or more non-transitory storage media storing one or more computer programs including computer-executable instructions that, when executed by one or more processors of an electronic device individually or collectively, cause the electronic device to perform operations are provided. The operations include, while a video is being played back in the forward direction, determining, among frames decoded to play back the video in the forward direction, a plurality of frames capable of being played back for a time required for decoding frames for reverse playback of the video when the video is played back in reverse, storing the determined plurality of frames in memory of the electronic device, in case that the video is played back in reverse, playing back the stored plurality of frames in the reverse direction, and in case that the playback of the stored plurality of frames is completed, playing back, in the reverse direction, the frames decoded for reverse playback of the video.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device according to an embodiment of the disclosure;

FIGS. 3A and 3B are diagrams for illustrating an operation of storing a plurality of frames for reverse playback of a video by an electronic device in a state where a reverse playback start time of the video is determined, according to various embodiments of the disclosure;

FIGS. 4A, 4B, and 4C are diagrams for illustrating an operation of storing a plurality of frames for reverse playback of a video by an electronic device in a state where a reverse playback start time of the video is not determined, according to various embodiments of the disclosure;

FIG. 5 is a diagram for illustrating an operation of storing a plurality of frames for reverse playback of a video by an electronic device when a plurality of videos are merged, according to an embodiment of the disclosure;

FIG. 6 is a flowchart for illustrating an operation of playing back a video in reverse by an electronic device according to an embodiment of the disclosure;

FIG. 7 is a flowchart for illustrating an operation of playing back a video in reverse by an electronic device in a state where a reverse playback start time of the video is determined, according to an embodiment of the disclosure;

FIG. 8 is a flowchart for illustrating an operation of playing back a video in reverse by an electronic device in a state where a reverse playback start time of the video is not determined, according to an embodiment of the disclosure;

FIGS. 9A and 9B are flowcharts for illustrating an operation of playing back a video in reverse by an electronic device in a state where a reverse playback start time of the video is not determined, according to various embodiments of the disclosure; and

FIG. 10 is a flowchart for illustrating an operation of playing back a video in reverse by an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

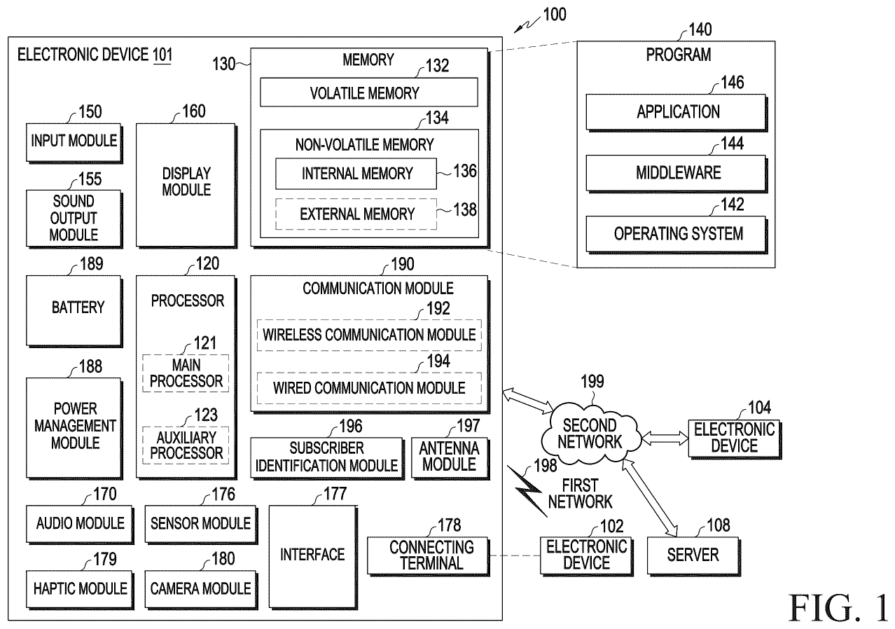

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mM TC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

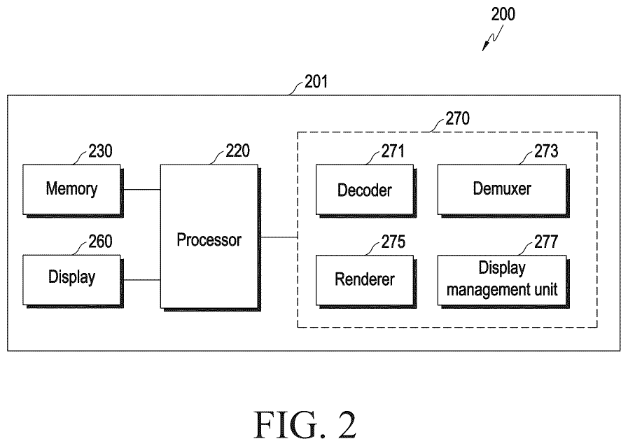

FIG. 2 is a block diagram 200 of an electronic device according to an embodiment of the disclosure.

Referring to FIG. 2, according to an embodiment, an electronic device 201 may include a processor 220, memory 230, a display 260, and a video playback management unit 270.

At least some of the components of the electronic device 201 illustrated in FIG. 2 may be identical or similar to the components of the electronic device 101 of FIG. 1, and hereinafter, duplicate descriptions will be omitted.

According to an embodiment, the processor 220 may be implemented substantially identically or similarly to the processor 120 of FIG. 1.

According to an embodiment, when forward playback of a video starts, the processor 220 may identify possibility of reverse playback of the video.

According to an embodiment, when the start of the forward playback of the video is identified, the processor 220 may identify whether a reverse playback start time of the video has been determined. For example, when first information, which indicates that an application related to playback of the video is able to support reverse playback of the video, is received from the application, the processor 220 may identify, based on the first information, whether a reverse playback start time of the video has been determined. The application related to playback of the video may determine a forward playback end time to be a start time of the reverse direction when a playback time of the video is less than or equal to a threshold time, determine a reverse playback start time selected by a user or edited by the user, determine, to be the reverse playback start time, a forward playback end time for a playback section frequently repeated by the user in the video, determine, to be the reverse playback start time, a forward playback end time for a playback section played back in reverse by the user in the video, or determine, based on analysis of the video, a section of interest of the user to be the reverse playback start time, and may transmit information on the determined reverse playback start time to the processor 220 by including the same in the first information.

According to an embodiment, the processor 220 may, while the video is being played back in the forward direction, determine, among frames decoded to play back the video in the forward direction, a plurality of frames capable of being played back for a time required for decoding frames for reverse playback of the video when the video is played back in reverse, and may store the determined plurality of frames in the memory 230.

According to an embodiment, the processor 220 may determine the plurality of frames so that, when playing back the video in reverse, a reverse playback completion time of the stored plurality of frames is longer than or equal to the time required for decoding the frames for reverse playback of the video.

According to an embodiment, when playing back the video in the forward direction, if it is identified that the reverse playback start time of the video has been determined, the processor 220 may, while the video is being played back in the forward direction, determine, among frames decoded to play back the video in the forward direction, plurality of frames to be played back from the reverse playback start time of the video when the video is played back in reverse, and may store the determined plurality of frames in the memory 230. The processor 220 may determine the plurality of frames so that, when playing back the video in reverse, a playback completion time of the stored plurality of frames from the reverse playback start time of the video is longer than or equal to the time required for decoding the frames for reverse playback of the video.

According to an embodiment, the processor 220 may detect a first previous sync frame (I frame) that is closest to the reverse playback start time of the video and a second previous sync frame (I frame) that is second closest to the reverse playback start time of the video. If a time required for decoding from the second sync frame to the first sync frame is less than a playback time from the reverse playback start time of the video to the first sync frame, the processor 220 may determine the plurality of frames in a first frame group including the first sync frame. If the time required for decoding from the second sync frame to the first sync frame is greater than the playback time from the reverse playback start time of the video to the first sync frame, the processor 220 may determine the plurality of frames in the first frame group including the first sync frame and a second frame group including the second sync frame.

According to an embodiment, when a video is played back in the forward direction, if it is identified that no reverse playback start time of the video has been determined, the processor 220 may, while the video is being played back in the forward direction, determine, among frames decoded to play back the video in the forward direction, a plurality of frames to be played back from a current forward playback time of the video when the video is played back in reverse, and the processor 220 may store the determined plurality of frames in the memory 230. The processor 220 may determine the plurality of frames so that, when playing back the video in reverse, a playback completion time of the stored plurality of frames from the current forward playback time of the video is longer than or equal to a time required for decoding frames for reverse playback of the video.

According to an embodiment, the processor 220 may detect a first previous sync frame (I frame) that is closest to the current forward playback time of the video and a second previous sync frame (I frame) that is second closest to the current forward playback time of the video. If a time required for decoding from the second sync frame to the first sync frame is less than a playback time from the current forward playback time of the video to the first sync frame, the processor 220 may determine the plurality of frames in a first frame group including the first sync frame. If the time required for decoding from the second sync frame to the first sync frame is greater than the playback time from the current forward playback time of the video to the first sync frame, the processor 220 may determine the plurality of frames in the first frame group including the first sync frame and a second frame group including the second sync frame.

According to an embodiment, based on Equation 1 below, the processor 220 may, while the video is being played back in the forward direction, determine, among frames decoded to play back the video in the forward direction, a plurality of frames (backup) capable of being played back for a time required for decoding frames for reverse playback of the video when the video is played back in reverse.

$$Equation 1$$

$$if \text{} ( ( {2}^{n d} y - {1}^{st} y ) ⋆ ( 1 / decoder fps ) < ( end time - {1}^{st} sync frame ) / rate ) ) \text{} \{ backup ⋆ ( 1 / {1}^{st} video fps ) / rate >= ( {1}^{st} y - backup ) ⋆ ( 1 / decorder fps ) \} else \{ backup ⋆ ( 1 / {2}^{n d} video fps ) \text{} / rate >= ( {2}^{n d} y - backup ) ⋆ ( 1 / decoder fps ) \}$$

end time: a frame timestamp of a reverse playback start point in a state where a reverse playback start time of the video has been determined, and a frame timestamp of a current forward playback time of the video in a state where no reverse playback start time of the video has been determined
1^{st} sync frame: a position of a first previous sync frame (I frame) that is closest to the end time
2^{nd} sync frame: a position of a second previous sync frame (I frame) that is second closest to the end time
1^{st} video fps: a video fps from the 1^{st} sync frame to the end time
2^{nd} video fps: a video fps from the 2^{nd} sync frame to the end time
(2^{nd} y−1^{st} y)*(1/decoder fps): a time required for decoding from the 2^{nd} to 1^{st} sync frames
1^{st} y: the number of frames from the 1^{st} sync frame to the end time
2^{nd} y: the number of frames from the 2^{nd} sync frame to the end time
(end time−1^{st} sync frame)/rate: a time required for playback from the end time to the 1^{st} sync frame
decoder fps: a maximum number of frames per second (fps) of a decoder
rate: a playback speed
backup: the number of a plurality of frames for reverse playback of the video

According to an embodiment, when it is identified that a reverse playback start time of the video has been determined, the processor 220 may identify a forward playback section, a reverse playback section, and a playback rate (e.g., 0.5×, 1×, 2×) of the video. For example, the processor 220 may identify the playback rate, the forward playback section, and the reverse playback section of the video, based on the first information received from the application related to playback of the video, as shown in Table 1 below.

TABLE 1

| Playback section (ms) | Playback direction | Playback rate |
|---|---|---|
| 1000-3000 | Forward direction | 2.0x |
| 3000-1000 | Reverse direction | 2.0x |
| 1000-3000 | Forward direction | 2.0x |
| 3000-1000 | Reverse direction | 2.0x |

As shown in Table 1, the processor 220 may identify that the video may be played back in the forward direction in a playback section of 1000 ms-3000 ms at a playback rate of 2×, played back in reverse in a playback section of 3000 ms-1000 ms, played back in the forward direction again in the playback section of 1000 ms-3000 ms, and played back in reverse in the playback section of 3000 ms-1000 ms. According to an embodiment, when it is identified that no reverse playback start time of the video has been determined, the processor 220 may identify a forward playback section and a playback rate (e.g., 0.5×, 1×, or 2×) of the video, based on the first information received from the application related to playback of the video. According to an embodiment, the processor 220 may acquire a maximum number of frames per second (fps) of a decoder from the decoder 271 of the video playback management unit 270. For example, Table 2 below shows decoder performance indexes for the AVC codec provided by the decoder 271.

TABLE 2

| | Pixels- | | FPS (frames |
|---|---|---|---|
| Video codec | per-second | Resolution | per second) |
| AVC | 248,832,000 | 1280 × 720 | 270 |
| | | 1920 × 1080 | 120 |
| | | 3840 × 2160 | 30 |

The decoder 271 may provide frames per second (fps) for each resolution with respect to various video codecs. HW video codecs used in electronic devices may provide index values for performance that can be processed per second. Generally, each of block-size and blocks-per-second values is provided, and when the block-size is 16×16 and the blocks-per-second value is 972,000, a pixels-per-second value becomes 248,832,000 (16×16×972,000). Table 2 shows values of the maximum number of frames per second (fps) in consideration of resolutions according to the pixels-per-second value calculated via the block-size and blocks-per-second values. For a resolution of 1280×720, it may be seen that the maximum performance is 270 fps (270 fps=248,832,000/1280/720). For a resolution of 1920×1080, it may be seen that the maximum performance is 120 fps (120 fps=248,832,000/1920/1080). For a resolution of 3840×2160, it may be seen that the maximum performance is 30 fps (30 fps=248,832,000/3840/2160). The processor 220 may receive resolution information and a codec type of the video to be played back from the decoder 271 so as to identify the value of the maximum number of frames per second (fps) for the codec. According to an embodiment, the processor 220 may acquire frame information (e.g., frame position information and frame type information) of the video from a demuxer 273 of the video playback management unit 270. The processor 220 may detect, based on the frame information received from the demuxer 273, the “−1^{st} sync frame” indicating the position of the first previous sync frame (I frame) that is closest to the end time (the frame timestamp of the reverse playback start point in a state where the reverse playback start time of the video has been determined) and the “−2^{nd} sync frame” indicating the position of the second previous sync frame (I frame) that is second closest to the end time (the frame timestamp of the reverse playback start point in a state where the reverse playback start time of the video has been determined) in the Equation 1. The processor 220 may detect, based on the frame information received from the demuxer 273, the “−1^{st} y” which is the number of frames from the 1^{st} sync frame to the end time (the frame timestamp of the reverse playback start point in a state where the reverse playback start time of the video has been determined) and the “−2^{nd} y” which is the number of frames from the 2^{nd} sync frame to the end time (the frame timestamp of the reverse playback start point in a state where the reverse playback start time of the video has been determined) in the Equation 1.

For example, as shown in Table 3 below, the processor 220 may acquire frame position (timestamp) information and frame type (video frame type) information, as the frame information of the video from the demuxer 273.

TABLE 3

| Timestamp (unit: ms) | Video frame type |
|---|---|
| 0 | I Frame |
| 33 | P Frame |
| 66 | P Frame |
| 100 | I Frame |
| 133 | P Frame |
| 166 | P Frame |
| 200 | I Frame |
| 233 | P Frame |
| 266 | P Frame |
| 300 | I Frame |
| 333 | P Frame |
| 366 | P Frame |

The processor 220 may identify, based on Table 3, that when the reverse playback start time of the video is “233 ms”, the position of the 1^{st} previous sync frame is “200 ms” and the position of the 2^{nd} previous sync frame is “100 ms”. The processor 220 may detect that “−1^{st} y” indicating the number of frames from the 1^{st} sync frame to the end time (the frame timestamp of the reverse playback start point in a state where the reverse playback start time of the video has been determined) is 2 (200 ms and 233 ms), and that “−2^{nd} y” indicating the number of frames from the 2^{nd} sync frame to the end time (the frame timestamp of the reverse playback start point in a state where the reverse playback start time of the video has been determined) is 3 (100 ms, 133 ms, and 166 ms). For example, as shown in Table 4 below, the processor 220 may acquire frame position (timestamp) information and frame type (video frame type) information, as the frame information of the video from the demuxer 273.

TABLE 4

| Timestamp (unit: ms) | Video frame type |
|---|---|
| 0 | I Frame |
| 33 | B Frame |
| 66 | B Frame |
| 100 | P Frame |
| 133 | B Frame |
| 166 | B Frame |
| 200 | I Frame |
| 233 | B Frame |
| 266 | B Frame |
| 300 | P Frame |
| 333 | B Frame |
| 366 | B Frame |
| 400 | I Frame |

The processor 220 may identify, based on Table 4, that when the reverse playback start time of the video is “233 ms”, the position of the 1^{st} previous sync frame is “200 ms” and the position of the 2^{nd} previous sync frame is “0 ms”. The processor 220 may identify that “−1^{st} y” indicating the number of frames from the 1^{st} sync frame to the end time (the frame timestamp of the reverse playback start point in a state where the reverse playback start time of the video has been determined) is 3 (200 ms, 233 ms, and 300 ms). Since “233 ms” that is the reverse playback start time is a B frame, and thus a P frame or an I frame to be referenced to decode the B frame is required, the processor 220 may detect 200 ms, 233 ms, and 300 ms as “−1^{st} y”. The processor 220 may detect that “−2^{nd} y” indicating the number of frames from the 2^{nd} sync frame to the end time (the frame timestamp of the reverse playback start point in a state where the reverse playback start time of the video has been determined) is 6 (0 ms, 33 ms, 66 ms, 100 ms, 133 ms, and 166 ms). According to an embodiment, while the video is being played back in the forward direction, if the processor 220 determines, among frames decoded to play back the video in the forward direction, a plurality of frames (e.g., backup in Equation 1) capable of being played back for a time required for decoding frames for reverse playback of the video when the video is played back in reverse, the processor 220 may acquire a display refresh rate from the display management unit 277 of the video playback management unit 270, and if the display refresh rate is lower than a playback frame rate, the processor 220 may store, in the memory 230, a plurality of frames obtained by skipping some frames among the determined plurality of frames. For example, Table 5 below shows display refresh rates provided by the display management unit 277 of the video playback management unit 270.

TABLE 5

| Display refresh rate mode | Refresh rate (HZ) |
|---|---|
| Variable | 30 |
| | 60 |
| | 120 |
| Fixed | 60 |

For example, if a current display refresh rate mode is variable, the maximum refresh rate may be 120 HZ, and if the current display refresh rate mode is fixed, the maximum refresh rate may be 60 HZ. The processor 220 may identify a display refresh rate value, compare the display refresh rate with a playback frame rate (playback frame rate=video fps*playback rate) value, and if a result of the comparison shows that the display refresh rate value is smaller than the playback frame rate value, the playback frame rate cannot be fully output, so that a frame skip ratio may be calculated by considering the display refresh rate.

For example, when the processor 220 identifies the display refresh rate value of 60 and the playback frame rate value of 120, and identifies “playback frame rate value/display refresh rate=2”, a skip ratio (frame skip ratio) of “0.5” obtained by dividing “1” by the calculation result value of “2” may be detected. The processor 220 may add the skip ratio to each of the plurality of frames determined for reverse playback of the video, and store, in the memory 230, only frames in which an integer value of a first digit is changed.

For example, as shown in Table 6 below, the processor 220 may not apply the skip ratio to a first frame among five frames determined for reverse playback of the video, and obtain a calculated value of “0” to identify the first frame as a frame for reverse playback of the video. The processor 220 may add the skip ratio of “0.5” to a “0” value of a second frame to obtain a calculated value of “0.5”, and compare the calculated value with “0” that is the calculated value of the first frame, so as to skip the Second frame due to the identical first integer value (“0”). The processor 220 may add the skip ratio of “0.5” to a “0.5” value of a third frame to obtain a calculated value of “1”, and compare the calculated value with “0” that is the calculated value of the second frame, so as to identify the third frame as a frame for reverse playback of the video due to a non-identical first integer value. The processor 220 may add the skip ratio of “0.5” to a “1” value of a fourth frame to obtain a calculated value of “1.5”, and compare the calculated value with “1” that is the calculated value of the third frame, so as to skip the fourth frame due to the identical first integer value (“1”). The processor 220 may add the skip ratio of “0.5” to a “1.5” value of a fifth frame to obtain a calculated value of “2”, and compare the calculated value with “1.5” that is the calculated value of the fourth frame, so as to identify the fifth frame as a frame for reverse playback of the video due to a non-identical first integer value. The processor 220 may store, in the memory 230, only three frames (1^{st}, 3^{rd} and 5^{th} frames) out of the five frames by using the frame skip ratio.

TABLE 6

| Target frames | | Calculated values |
|---|---|---|
| for reverse | | to which frame |
| playback of | Whether | skip ratio (0.5) |
| video | to store | has been applied |
| 1 | ◯ | 0 |
| 2 | X | 0.5 |
| 3 | ◯ | 1 |
| 4 | X | 1.5 |
| 5 | ◯ | 2 |

According to an embodiment, when a video resolution is higher than a display resolution, the processor 220 may resize resolutions of the plurality of frames determined for reverse playback of the video to the display resolution, and then store the same in the memory 230. If the resolution of the video being played back is high resolution, such as 4K or 8K, a memory size for storing the plurality of frames determined for reverse playback of the video also needs to be increased for seamless reverse playback. For example, a memory size corresponding to a decoded YUV format, the resolution of 3840×2160, is 12 MB, and when a plurality of frames of 100 frames are required for reverse playback, 1.17 GB (1200 M B) of memory is required. When the memory is used as mentioned above, a memory shortage may occur in the electronic device, so that, for a high-resolution video, the processor 220 may compare a display resolution with a video resolution, and if a result of the comparison shows that the video resolution is greater than the display resolution, a plurality of frames determined for reverse playback of the video may be resized to the display resolution and then stored in the memory 230. For example, the plurality of frames may be video-resized to the display resolution by using a graphic processing unit (GPU), a digital signal processor (DSP), or a neural processor (NPU) for efficient processing. For example, when the display resolution is 1920×1080 and the video resolution is 3840×2160, the processor 220 may reduce the memory size to 3 M B by resizing the plurality of frames determined for reverse playback of the video to 1920×1080 and storing the same. According to an embodiment, for reverse playback of a video in an external electronic device which may be connected to communicate with the electronic device 201, in consideration of capability (e.g., a display resolution and a display refresh rate) of a display of the external electronic device, the processor 220 may, while the video is being played back in the forward direction, determine, among frames decoded to play back the video in the forward direction, a plurality of frames (backup) capable of being played back for a time required for decoding frames for reverse playback of the video when the video is played back in reverse.

For example, if a display refresh rate value of the external electronic device is 10 HZ and a playback frame rate value is 120, and the processor 220 identifies that “playback frame rate value/display refresh rate value=12”, a skip ratio (frame skip ratio) of “0.83 (=10/120)” obtained by dividing “1” by the calculation result value of “12” may be detected. As shown in Table 6, the processor 220 may separately store, in the memory 230, a plurality of frames obtained by skipping some frames among the plurality of frames determined for reverse playback of the video. In addition, when the display resolution of the external electronic device is 720×480, and the resolution of the video is 3840×2160, the processor 220 may resize the plurality of frames determined for reverse playback of the video to 720×480 and then separately store the same in the memory 230.

When transmitting the video to the external electronic device, the processor 220 may also transmit the plurality of frames separately stored in the memory 230 for the external electronic device.

According to an embodiment, the processor 220 may, when playing back the video in reverse, play back the plurality of frames stored in the memory 230 in the reverse direction, decode frames for reverse playback of the video while playing back the stored plurality of frames in reverse, and when the playback of the stored plurality of frames is completed, play back, in the reverse direction, the frames decoded for reverse playback of the video.

According to an embodiment, in a state where a reverse playback start time of the video has been determined, when reverse playback of the video starts, the processor 220 may play back the stored plurality of frames in the reverse direction from the reverse playback start time of the video, and while the stored plurality of frames are being played back in the reverse direction, decode frames from a first frame of the video to a frame before the stored plurality of frames. When the reverse playback of the stored plurality of frames is completed, the processor 220 may play back the decoded frames sequentially in the reverse direction. The processor 220 may delete, from the memory 230, a frame that has been played back among the plurality of frames stored in the memory 230.

According to an embodiment, in a state where no reverse playback start time of the video has been determined, the processor 220 may determine, among frames decoded to play back the video in the forward direction, a plurality of frames capable of being played back in the reverse direction from a current forward playback time of the video, and store the plurality of frames in the memory 230. The processor 220 may, when the current forward playback time of the video is changed, delete the plurality of previous frames stored in the memory 230, determine a plurality of frames capable of being played back in the reverse direction from the changed current forward playback time of the video among frames decoded for playing back the video in the forward direction, and newly store the plurality of frames in the memory 230. After newly storing the plurality of frames in the memory 230, when a request for reverse playback of the video is identified, the processor 220 may play back the stored plurality of frames in the reverse direction from a point in time when the request for reverse playback of the video is identified, and while the stored plurality of frames are being played back in the reverse direction, decode frames from the first frame of the video to a frame before the stored plurality of frames. When the reverse playback of the stored plurality of frames is completed, the processor 220 may play back the decoded frames sequentially in the reverse direction. The processor 220 may delete, from the memory 230, a frame that has been played back among the plurality of frames stored in the memory 230.

According to an embodiment, the memory 230 may be implemented substantially the same as or similar to the memory 130 of FIG. 1.

According to an embodiment, the memory 230 may store a plurality of frames capable of being played back for a time required for decoding frames for reverse playback of a video when playing the video back in reverse.

According to an embodiment, the display 260 may be implemented substantially the same as or similar to the display module 160 of FIG. 1.

According to an embodiment, the display 260 may display forward playback of a video and reverse playback of the video.

According to an embodiment, the video playback management unit 270 may include a decoder 271, a demuxer 273, a renderer 275, and a display management unit 277.

According to an embodiment, the video playback management unit 270 may operate under the control of the processor 220, and the processor 220 may include a separate playback unit and a frame management unit. The playback unit may control the video playback management unit 270 and the frame management unit, and may manage and control a playback rate of a video, switching between forward playback and reverse playback of the video, position movement, and playback information of a section. The frame management unit may determine a plurality of frames for reverse playback of a video, determine a plurality of frames for reverse playback of the video in consideration of a display refresh rate, and control the decoder.

According to an embodiment, the processor 220 may perform the same operation as that of the video playback management unit 270.

According to an embodiment, the decoder 271 may decode video and audio of a video and provide information on codec performance to the processor 220.

According to an embodiment, the demuxer 273 may perform file demuxing on a media file, identify frame information (e.g., position information (timestamp) and type information (e.g., I frame, P frame, or B frame)) on a plurality of frames included in a video, and provide the frame information to the processor 220.

According to an embodiment, the renderer 275 may output, via the display 260 and a speaker, video and audio received from the processor 220.

According to an embodiment, the display management unit 277 may identify a display refresh rate and provide display refresh rate information to the processor 220.

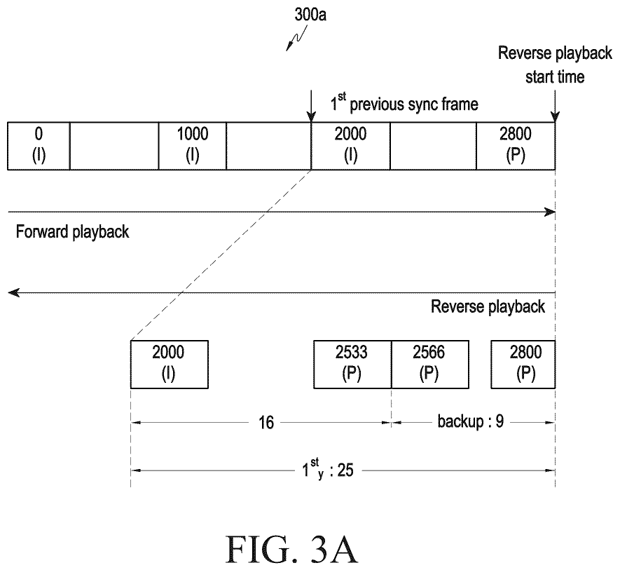

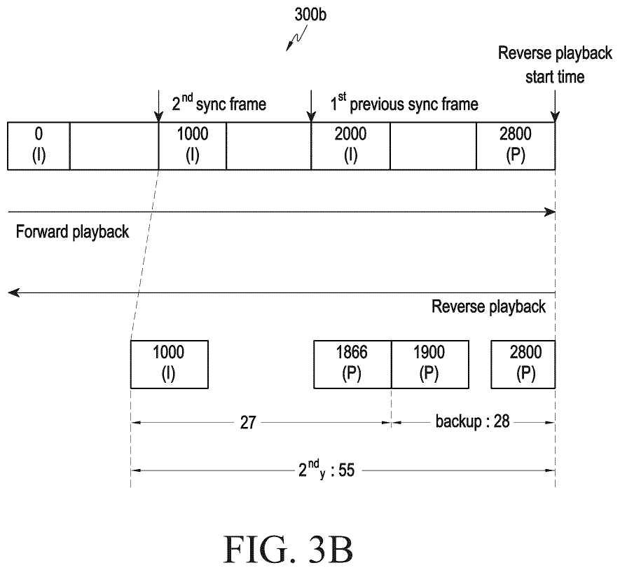

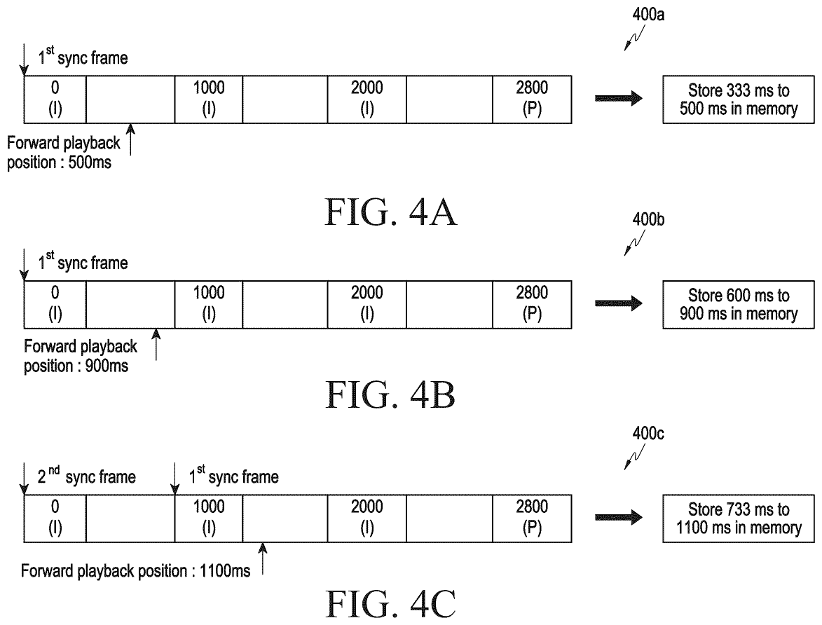

FIGS. 3A and 3B are diagrams 300a and 300b for illustrating an operation of storing a plurality of frames for reverse playback of a video by an electronic device in a state where a reverse playback start time of the video is determined, according to various embodiments of the disclosure. FIGS. 4A, 4B, and 4C are diagrams 400a, 400b, and 400c for illustrating an operation of storing a plurality of frames for reverse playback of a video by an electronic device in a state where a reverse playback start time of the video is not determined, according to various embodiments of the disclosure.

FIGS. 3A, 3B, 4A, 4B, and 4C may describe operations in which an electronic device (e.g., the electronic device of FIG. 1 and/or the electronic device of FIG. 2) acquires frame information, such as Table 7, from a demuxer (e.g., the demux 273 of FIG. 2), makes an assumption of “decoder fps: 60” and “1^{st} video fps and 2^{nd} video fps: 30”, and determines a plurality of frames to be stored for reverse playback of a video.

TABLE 7

| Timestamp (unit: ms) | Video frame type |
|---|---|
| 0 | I Frame |
| 33-966 (interval of 33.33 ms, total 29) | P Frame |
| 1000 | I Frame |
| 1033-1966 (interval of 33.33 ms, total 29) | P Frame |
| 2000 | I Frame |
| 2033-2966 (interval of 33.33 ms, total 29) | P Frame |
| 3000 | I Frame |
| 3033-3966 (interval of 33.33 ms, total 29) | P Frame |
| 4000 | I Frame |
| 4033-4966 (interval of 33.33 ms, total 29) | P Frame |

Referring to FIG. 3A, the electronic device (e.g., the electronic device of FIG. 1 and/or the electronic device of FIG. 2) may identify the following values.
playback rate: 1.0
end time (reverse playback start time): 2800
1^{st} sync frame: 2000,
2^{nd} sync frame: 1000
(2^{nd} y−1^{st} y)*(1/decoder fps): 500 ms (30*(1/60))
(end time−1^{st} sync frame)/rate: 800 ms (2800−2000)/1.0
1^{st} y: 25 (number of frames from 2000 ms to 2800 ms)

The electronic device may apply these values to “((2^{nd} y−1^{st} y)*(1/decoder fps)<(end time−1^{st} sync frame)/rate))” which is a first calculation expression in the Equation 1, and based on the condition of the first calculation expression being satisfied, determine a plurality of frames to be stored for reverse playback of the video by using “backup*(1/1^{st} video fps)/rate>=(1^{st} y−backup)*1/decoder fps” which is a second calculation expression enabling determination of the plurality of frames in the first frame group (1^{st} y) including the first previous sync frame that is closest to the reverse playback start time of the video.

The electronic device may calculate “9 (the number of frames)” as a backup value indicating a plurality of frames for reverse playback of the video via the second calculation expression, identify a frame of 2566 ms as a backup start time, determine, as the plurality of frames to be stored for reverse playback of the video, a total of 9 frames from the frame of 2566 ms to a frame of 2800 ms among frames decoded for forward playback of the video, and store the same in memory (e.g., the memory 230 of FIG. 2). When the video is played back in reverse, the electronic device may sequentially perform playback in the reverse direction from the frame of 2800 ms among the stored frames from 2566 ms to 2800 ms, and while the stored frames from 2566 ms to 2800 ms are being played back sequentially in the reverse direction, decode on frames of the video from 2000 ms to 2533 ms. When the playback of the stored frame of 2566 ms is completed, the electronic device may perform playback from the frame of 2533 ms among the decoded frames from 2000 ms to 2533 ms in the reverse direction. While playing back the decoded frames from 2000 ms to 2533 ms sequentially in the reverse direction, the electronic device may decode frames of the video from 1000 ms to 1966 ms. When the playback of the decoded frames from 2533 ms to 2000 ms is completed, the electronic device may perform playback from the frame of 1966 ms among the decoded frames from 1000 ms to 1966 ms in the reverse direction. While playing back the decoded frames from 1000 ms to 1966 ms sequentially in the reverse direction, the electronic device may decode frames of the video from 0 ms to 966 ms. When the playback of the decoded frames from 1966 ms to 1000 ms is completed, the electronic device may perform playback from the frame of 966 ms among the decoded frames from 0 ms to 966 ms in the reverse direction.

Referring to FIG. 3B, the electronic device (e.g., the electronic device of FIG. 1 and/or the electronic device of FIG. 2) may identify the following values.
playback rate: 2.0
end time (reverse playback start time): 2800
1^{st} sync frame: 2000, 2^{nd} sync frame: 1000
(2^{nd} y−1^{st} y)*(1/decoder fps): 500 ms (30*(1/60))
(end time−1^{st} sync frame)/rate: 400 ms (2800−2000)/2.0
2^{nd} y: 55 (number of frames from 1000 ms to 2800 ms)

The electronic device may apply these values to “((2^{nd} y−1^{st} y)*(1/decoder fps)<(end time−1^{st} sync frame)/rate))” which is the first calculation expression in the Equation 1, and based on the condition of the first calculation expression not being satisfied, determine a plurality of frames to be stored for reverse playback of the video by using “backup*(1/2^{nd} video fps)/rate>=(2^{nd} y−backup) * (1/decoder fps)” which is a third calculation expression enabling determination of the plurality of frames in the second frame group (2^{nd} y) including the second previous sync frame that is second closest to the reverse playback start time of the video.

The electronic device may calculate “28 (the number of frames)” as a backup value indicating a plurality of frames to be stored for reverse playback of the video via the third calculation expression, identify a frame of 1900 ms as a backup start time, determine, as the plurality of frames to be stored for reverse playback of the video, a total of 28 frames from the frame of 1900 ms to a frame of 2800 ms among frames decoded for forward playback of the video, and store the same in memory (e.g., the memory 230 of FIG. 2). When the video is played back in reverse, the electronic device may sequentially perform playback in the reverse direction from the frame of 2800 ms among the stored frames from 1900 ms to 2800 ms, and while the stored frames from 1900 ms to 2800 ms are being played back sequentially in the reverse direction, decode frames of the video from 1000 ms to 1866 ms. When the playback of the stored frame of 1900 ms is completed, the electronic device may perform playback from the frame of 1866 ms among the decoded frames from 1000 ms to 1866 ms in the reverse direction. While playing back the decoded frames from 1000 ms to 1866 ms sequentially in the reverse direction, the electronic device may decode frames of the video from 0 ms to 966 ms. When the playback of the decoded frames from 1866 ms to 1000 ms is completed, the electronic device may perform playback from the frame of 966 ms among the decoded frames from 0 ms to 966 ms in the reverse direction.

Referring to FIG. 4A, the electronic device (e.g., the electronic device of FIG. 1 and/or the electronic device of FIG. 2) may, while playing back a video in the forward direction, identify the following values when a current forward playback time of the video is identified to be 500 ms.
playback rate: 1.0
(2^{nd} y−1^{st} y)*(1/decoder fps): 0 ms
end time (current forward playback time point): 500 ms

The electronic device may apply these values to “((2^{nd} y−1^{st} y)*(1/decoder fps)<(end time−1^{st} sync frame)/rate))” which is the first calculation expression in the Equation 1, and based on the condition of the first calculation expression being satisfied, determine a plurality of frames to be stored for reverse playback of the video by using “backup*(1/1^{st} video fps)/rate>=(1^{st} y−backup) * 1/decoder fps” which is the second calculation expression enabling determination of the plurality of frames in the first frame group (1^{st} y) including the first previous sync frame that is closest to the reverse playback start time of the video.

The electronic device may calculate “6 (the number of frames)” as a backup value indicating a plurality of frames to be stored for reverse playback of the video via the second calculation expression, determine, as the plurality of frames to be stored for reverse playback of the video, a total of 6 frames from a frame of 333 ms to a frame of 500 ms among frames decoded for forward playback of the video, and store the same in memory (e.g., the memory 230 of FIG. 2).

Referring to FIG. 4B, when forward playback of the video is in progress and the current forward playback time of the video is identified to be 900 ms, the following values may be identified.
playback rate: 1.0
(2^{nd} y−1^{st} y)*(1/decoder fps): 0 ms
end time (current forward playback time point): 900 ms

The electronic device may apply these values to “((2^{nd} y−1^{st} y)*(1/decoder fps)<(end time−1^{st} sync frame)/rate))” which is the first calculation expression in the Equation 1, and based on the condition of the first calculation expression being satisfied, determine a plurality of frames to be stored for reverse playback of the video by using “backup*(1/1^{st} video fps)/rate>=(1^{st} y−backup)*1/decoder fps” which is the second calculation expression enabling determination of the plurality of frames in the first frame group (1^{st} y) including the first previous sync frame that is closest to the reverse playback start time of the video.

The electronic device may calculate “10 (the number of frames)” as a backup value indicating a plurality of frames to be stored for reverse playback of the video via the second calculation expression, determine, as the plurality of frames to be stored for reverse playback of the video, a total of 10 frames from a frame of 600 ms to a frame of 900 ms among frames decoded for forward playback of the video, and store the same in memory (e.g., the memory 230 of FIG. 2). The electronic device may delete previously stored frames from 333 ms to 500 ms, and store the frames from 600 ms to 900 ms.

Referring to FIG. 4C, when forward playback of the video is in progress and the current forward playback time of the video is identified to be 1100 ms, the following values may be identified.
playback rate: 1.0
(2^{nd} y−1^{st} y)*(1/decoder fps): 500 ms
end time (current forward playback time point): 1100 ms

The electronic device may apply these values to “((2^{nd} y−1^{st} y)*(1/decoder fps)<(end time−1^{st} sync frame)/rate))” which is the first calculation expression in the Equation 1, and based on the condition of the first calculation expression not being satisfied, determine a plurality of frames to be stored for reverse playback of the video by using “backup*(1/2^{nd} video fps)/rate>=(2^{nd} y−backup)*(1/decoder fps)” which is the third calculation expression enabling determination of the plurality of frames in the second frame group (2^{nd} y) including the second previous sync frame that is second closest to the reverse playback start time of the video.

The electronic device may calculate “14 (the number of frames)” as a backup value indicating a plurality of frames to be stored for reverse playback of the video via the third calculation expression, determine, as the plurality of frames to be stored for reverse playback of the video, a total of 14 frames from a frame of 733 ms to a frame of 1100 ms among frames decoded for forward playback of the video, and store the same in memory (e.g., the memory 230 of FIG. 2). The electronic device may delete previously stored frames from 600 ms to 900 ms, and store the frames from 733 ms to 1100 ms.

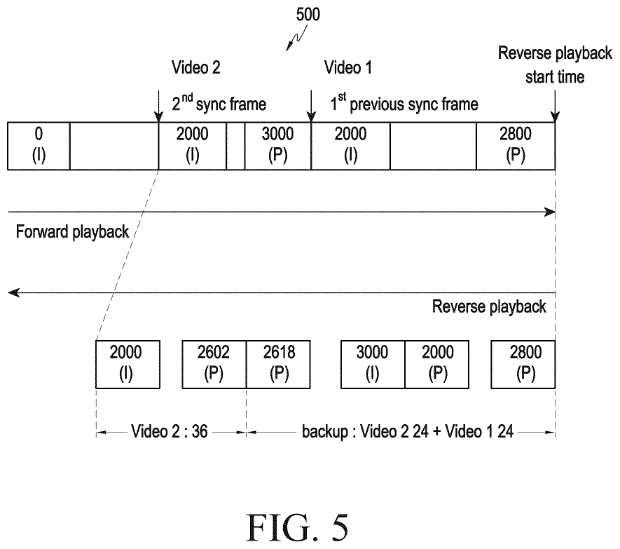

FIG. 5 is a diagram 500 for illustrating an operation of storing a plurality of frames for reverse playback of a video by an electronic device when a plurality of videos are merged, according to an embodiment of the disclosure.

Referring to FIG. 5, an electronic device (e.g., electronic device 101 of FIG. 1 and/or electronic device 201 of FIG. 2) may identify the following values when two videos are merged, wherein it is assumed that a decoder fps of a first video (Video1) is 30, a video fps of the first video (Video1) is 30, a decoder fps of a second video (Video2) is 60, and a video fps of the second video (Video2) is 60.
playback rate: 2.0
end time (reverse playback start time): 2800
1^{st} sync frame: 2000(Video1),
2^{nd} sync frame: 2000(Video2)
(2^{nd} y−1^{st} y)*(1/Video2 decoder fps): 1000 ms (60*(1/60))
(end time−1^{st} sync frame)/rate: 400 ms (2800−2000)/2.0
2^{nd} y: 24 for Video1 (the number of frames for Video1 from 2000 ms to 2800 ms), 60 for Video2 (the number of frames for Video2 from 2000 ms to 3000 ms)

The electronic device may apply these values to “((2^{nd} y−1^{st} y)*(1/decoder fps)<(end time−1^{st} sync frame)/rate))” which is the first calculation expression in the Equation 1, and if the condition of the first calculation expression cannot be satisfied, the electronic device may determine a plurality of frames to be stored for reverse playback of the video, in which the two videos are merged, by using “((backup−1^{st} y)*(1/Video2 video fps)+(1^{st} y*(1/Video1 video fps))/rate>=(2^{nd}y−backup)*(1/Video2 decoder fps)” which is a new third calculation expression.

The electronic device may calculate, as a backup value indicating the plurality of frames to be stored, “24 (the number of frames)” for the second video (video2) and “24 (the number of frames)” for the first video (video) via the third calculation expression, and may identify a frame of 2618 ms as a point in time when the second video is started to be stored, and a frame of 2000 ms as a point in time when the first video is started to be stored. The electronic device may determine, as the plurality of frames to be stored for reverse playback of the video, frames from 2618 ms to 3000 ms for the second video and frames from 2000 ms to 2800 ms for the first video, and stores the same in memory (e.g., the memory 230 of FIG. 2).

When the video is played back in reverse, the electronic device may sequentially play back the stored frames from 2816 ms to 3000 ms of the second video and the stored frames from 2000 ms to 2800 ms of the first video in the reverse direction, and while the stored a plurality of frames are being played back in the reverse direction, the electronic device may decode frames of the video from 0 ms to 2602 ms. When the playback of the stored a plurality of frames is completed, the electronic device may perform playback from the frame of 2602 ms among the decoded frames from 0 ms to 2602 ms in the reverse direction.

According to an embodiment, the electronic device (101 of FIG. 1; 201 of FIG. 2) may include a display (260 of FIG. 2), at least one processor (120 of FIG. 1; 220 of FIG. 2), and memory (230 of FIG. 2) storing instructions.

According to an embodiment, the instructions may, when executed by the at least one processor individually or collectively, cause the electronic device to, while a video is being played back in the forward direction, determine, among frames decoded to play back the video in the forward direction, a plurality of frames capable of being played back for a time required for decoding frames for reverse playback of the video when the video is played back in reverse, and may store the plurality of determined frames in the memory.

According to an embodiment, the instructions may, when executed by the at least one processor individually or collectively, cause the electronic device to, when the video is played back in reverse, play back the stored a plurality of frames in the reverse direction, and when the playback of the stored plurality of frames is completed, play back, in the reverse direction, the frames decoded for reverse playback of the video.

According to an embodiment, the instructions may, when executed by the at least one processor individually or collectively, cause the electronic device to determine the plurality of frames so that, when playing back the video in reverse, a reverse playback completion time of the stored plurality of frames is longer than or equal to the time required for decoding the frames for reverse playback of the video.

According to an embodiment, the instructions may, when executed by the at least one processor individually or collectively, cause the electronic device to, if a reverse playback start time of the video has been determined, determine, among the frames decoded to play back the video in the forward direction, a plurality of frames capable of being played back in the reverse direction from the reverse playback start time of the video.

According to an embodiment, the instructions, when executed by the at least one processor individually or collectively, cause the electronic device to detect a first previous sync frame that is closest to the reverse playback start time of the video and a second previous sync frame that is second closest to the reverse playback start time of the video.

According to an embodiment, the instructions may, when executed by the at least one processor individually or collectively, cause the electronic device to, if a time required for decoding from the second sync frame to the first sync frame is less than a playback time from the reverse playback start time of the video to the first sync frame, determine the plurality of frames in a first frame group including the first sync frame.

According to an embodiment, the instructions may, when executed by the at least one processor individually or collectively, cause the electronic device to, if the time required for decoding from the second sync frame to the first sync frame is greater than the playback time from the reverse playback start time of the video to the first sync frame, determine the plurality of frames in the first frame group including the first sync frame and a second frame group including the second sync frame.

According to an embodiment, the instructions t may, when executed by the at least one processor individually or collectively, cause the electronic device to, if no reverse playback start time of the video has been determined, determine, among the frames decoded to play back the video in the forward direction, a plurality of frames capable of being played back in the reverse direction from a current forward playback time of the video.

According to an embodiment, the instructions may, when executed by the at least one processor individually or collectively, cause the electronic device to detect a first previous sync frame that is closest to the current forward playback time of the video and a second previous sync frame that is second closest to the current forward playback time of the video.

According to an embodiment, the instructions may, when executed by the at least one processor individually or collectively, cause the electronic device to, if a time required for decoding from the second sync frame to the first sync frame is less than a playback time from the current forward playback time of the video to the first sync frame, determine the plurality of frames in a first frame group including the first sync frame.

According to an embodiment, the instructions may, when executed by the at least one processor individually or collectively, cause the electronic device to, if the time required for decoding from the second sync frame to the first sync frame is greater than the playback time from the current forward playback time of the video to the first sync frame, determine the plurality of frames in the first frame group including the first sync frame and a second frame group including the second sync frame.

According to an embodiment, the instructions may, when executed by the at least one processor individually or collectively, cause the electronic device to store the determined plurality of frames in the memory.

According to an embodiment, the instructions may, when executed by the at least one processor individually or collectively, cause the electronic device to, when the current forward playback time of the video is changed, delete the plurality of frames stored in the memory.

According to an embodiment, the instructions may, when executed by the at least one processor individually or collectively, cause the electronic device to determine a plurality of frames to be stored in the memory, based on the changed current forward playback time of the video.

According to an embodiment, the instructions may, when executed by the at least one processor individually or collectively, cause the electronic device to, if a display refresh rate is lower than a playback frame rate, store, in the memory, a plurality of frames obtained by skipping at least one frame based on the display refresh rate from among the determined plurality of frames.

According to an embodiment, the instructions may, when executed by the at least one processor individually or collectively, cause the electronic device to, if a video resolution is higher than a display resolution, resize resolutions of the determined plurality of frames to the display resolution, and then store the same in the memory.

According to an embodiment, the instructions may, when executed by the at least one processor individually or collectively, cause the electronic device to delete, from the memory, a frame that has been played back among the stored plurality of frames.

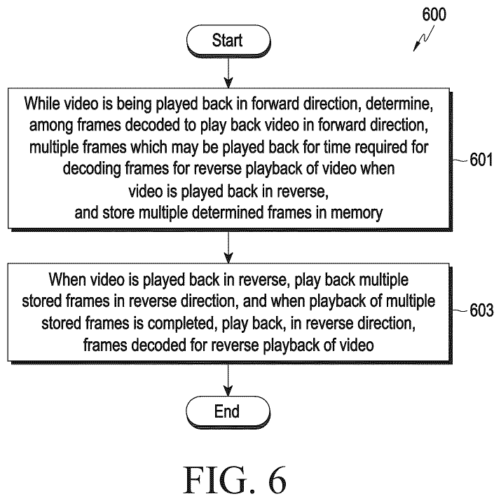

FIG. 6 is a flowchart 600 for illustrating an operation of playing back a video in reverse by an electronic device according to an embodiment of the disclosure. Operations of playing back the video in reverse may include operations 601 to 603. In the following embodiments, respective operations may be sequentially performed, but are not necessarily performed sequentially. For example, the order of the respective operations may be changed, at least two operations may be performed in parallel, or another operation may be added.

In operation 601, an electronic device (e.g., the electronic device 101 of FIG. 1 and/or the electronic device 201 of FIG. 2) may, while a video is being played back in the forward direction, determine, among frames decoded to play back the video in the forward direction, a plurality of frames capable of being played back for a time required for decoding frames for reverse playback of the video when the video is played back in reverse, and may store the determined plurality of frames in the memory.

According to an embodiment, when first information, which indicates that an application related to playback of the video is able to support reverse playback of the video, is received from the application when the video is played back, the electronic device may identify, based on the first information, whether a reverse playback start time of the video has been determined.

According to an embodiment, if it is identified, based on the first information, that a reverse playback start time of the video has been determined, the electronic device may determine, among frames decoded to play back the video in the forward direction, a plurality of frames to be played back from the reverse playback start time of the video when the video is played back in reverse, and may store the plurality of determined frames in the memory (e.g., the memory 230 of FIG. 2).

According to an embodiment, the electronic device may determine the plurality of frames so that, when playing back the video in reverse, a playback completion time of the stored a plurality of frames from the reverse playback start time of the video is longer than or equal to the time required for decoding the frames for reverse playback of the video.

According to an embodiment, the electronic device may detect a first previous sync frame that is closest to the reverse playback start time of the video and a second previous sync frame that is second closest to the reverse playback start time of the video. If a time required for decoding from the second sync frame to the first sync frame is less than a playback time from the reverse playback start time of the video to the first sync frame, the electronic device may determine the plurality of frames in a first frame group including the first sync frame. If the time required for decoding from the second sync frame to the first sync frame is greater than the playback time from the reverse playback start time of the video to the first sync frame, the electronic device may determine the plurality of frames in the first frame group including the first sync frame and a second frame group including the second sync frame.

According to an embodiment, when first information, which indicates that an application related to playback of the video is able to support reverse playback of the video, is received from the application when the video is played back, and it is identified that no reverse playback start time of the video has been determined, the electronic device may, while the video is being played back in the forward direction, determine, among frames decoded to play back the video in the forward direction, a plurality of frames to be played back from a current forward playback time of the video when the video is played back in reverse, and the electronic device may store the determined plurality of frames in the memory.

According to an embodiment, the electronic device may determine the plurality of frames so that, when playing back the video in reverse, a playback completion time of the stored plurality of frames from the current forward playback time of the video is longer than or equal to the time required for decoding the frames for reverse playback of the video.

According to an embodiment, the electronic device may detect a first previous sync frame that is closest to the current forward playback time of the video and a second previous sync frame that is second closest to the current forward playback time of the video. If a time required for decoding from the second sync frame to the first sync frame is less than a playback time from the current forward playback time of the video to the first sync frame, the electronic device may determine the plurality of frames in a first frame group including the first sync frame. If the time required for decoding from the second sync frame to the first sync frame is greater than the playback time from the current forward playback time of the video to the first sync frame, the electronic device may determine the plurality of frames in the first frame group including the first sync frame and a second frame group including the second sync frame.

In operation 603, the electronic device (e.g., the electronic device 101 of FIG. 1 and/or the electronic device 201 of FIG. 2) may, when the video is played back in reverse, play back the stored plurality of frames in the reverse direction, and when the playback of the stored plurality of frames is completed, play back, in the reverse direction, the frames decoded for reverse playback of the video.

According to an embodiment, in a state where a reverse playback start time of the video has been determined, when reverse playback of the video starts, the electronic device may play back the stored plurality of frames in the reverse direction from the determined reverse playback start time.

According to an embodiment, in a state where no reverse playback start time of the video has been determined, when a request for reverse playback of the video is identified while the video is being played back in the forward direction, the electronic device may play back the stored plurality of frames in the reverse direction from a point in time when the request for reverse playback of the video is identified.

According to an embodiment, the electronic device may decode frames for reverse playback of the video while the stored plurality of frames are being played back in the reverse direction.

According to an embodiment, the electronic device may, when the playback of the stored plurality of frames is completed, play back, in the reverse direction, the frames decoded for reverse playback of the video.

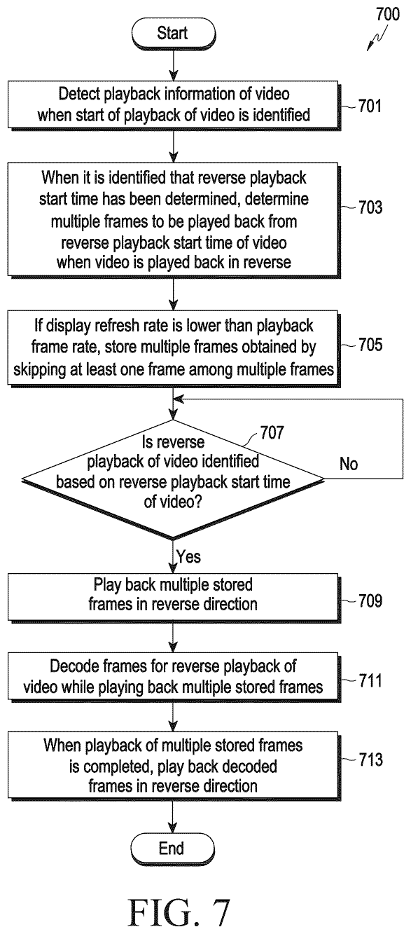

FIG. 7 is a flowchart 700 for illustrating an operation of playing back a video in reverse by an electronic device in a state where a reverse playback start time of the video is determined, according to an embodiment of the disclosure. Operations of detecting a plurality of frames for reverse playback of the video may include operations 701 to 713. In the following embodiments, respective operations may be sequentially performed, but are not necessarily performed sequentially. For example, the order of the respective operations may be changed, at least two operations may be performed in parallel, or another operation may be added.

In operation 701, an electronic device (e.g., electronic device 101 of FIG. 1 and/or electronic device 201 of FIG. 2) may detect playback information of a video when start of playback of the video is identified.

According to an embodiment, the electronic device may identify information indicating whether the video is switchable in reverse, playback section information, and playback rate information, based on first information received from an application related to playback of the video.

In operation 703, when the electronic device (e.g., electronic device 101 of FIG. 1 and/or electronic device 201 of FIG. 2) identifies that a reverse playback start time has been determined, the electronic device may determine a plurality of frames to be played back from the reverse playback start time of the video when the video is played back in reverse.

According to an embodiment, the electronic device may identify reverse playback section configuration information based on the first information received from the application related to playback of the video, and determine the reverse playback start time based on the reverse playback section configuration information.

According to an embodiment, when the electronic device identifies that the reverse playback start time of the video has been determined, the electronic device may, while the video is being played back in the forward direction, determine, among frames decoded to play back the video in the forward direction, a plurality of frames to be played back from the reverse playback start time of the video when the video is played back in reverse.

According to an embodiment, the electronic device may determine the plurality of frames so that, when playing back the video in reverse, a playback completion time of the stored plurality of frames from the reverse playback start time of the video is longer than or equal to the time required for decoding the frames for reverse playback of the video.

According to an embodiment, by using Equation 1, the electronic device may, while the video is being played back in the forward direction, determine, among the frames decoded to play back the video in the forward direction, a plurality of frames to be played back from the reverse playback start time of the video when the video is played back in reverse.

In operation 705, if a display refresh rate is lower than a playback frame rate, the electronic device (e.g., electronic device 101 of FIG. 1 and/or electronic device 201 of FIG. 2) may store a plurality of frames obtained by skipping at least one frame among the plurality of frames.

According to an embodiment, the electronic device may identify a display refresh rate value, compare the display refresh rate with a playback frame rate (playback frame rate=video fps*playback rate) value, and if a result of the comparison shows that the display refresh rate value is smaller than the playback frame rate value, the playback frame rate cannot be fully output, so that a frame skip ratio may be calculated by considering the display refresh rate. When the electronic device identifies “playback frame rate value/display refresh rate=a”, a skip ratio (frame skip ratio) of “1/a” obtained by dividing “1” by the calculation result value of “a” may be detected. The processor 220 may add the skip ratio to each of the plurality of frames determined for reverse playback of the video, and store, in memory (e.g., the memory of FIG. 2), only frames in which an integer value of a first digit is changed.

In operation 709, when the electronic device (e.g., the electronic device 101 of FIG. 1 and/or the electronic device 201 of FIG. 2) identifies reverse playback of the video in operation 707 based on the reverse playback start time of the video, the stored plurality of frames may be played back in the reverse direction.

According to an embodiment, the electronic device may play back the plurality of frames stored in the memory (e.g., the memory of FIG. 2) in the reverse direction when the reverse playback start time of the video arrives.

In operation 711, the electronic device (e.g., electronic device 101 of FIG. 1 and/or electronic device 201 of FIG. 2) may decode the frames for reverse playback of the video while playing back the stored plurality of frames.

According to an embodiment, while the plurality of frames stored in the memory are being played back in the reverse direction, the electronic device may perform decoding from a first frame of the video to a frame immediately before the stored plurality of frames.

In operation 713, the electronic device (e.g., electronic device 101 of FIG. 1 and/or electronic device 201 of FIG. 2) may play back the decoded frames in the reverse direction when the playback of the stored plurality of frames is completed.

According to an embodiment, when the playback of the stored plurality of frames is completed, the electronic device may play back the frames, which are decoded during the playback of the plurality of frames, in the reverse direction.

According to an embodiment, the electronic device may delete, from the memory, a frame that has been played back among the plurality of frames stored in the memory.

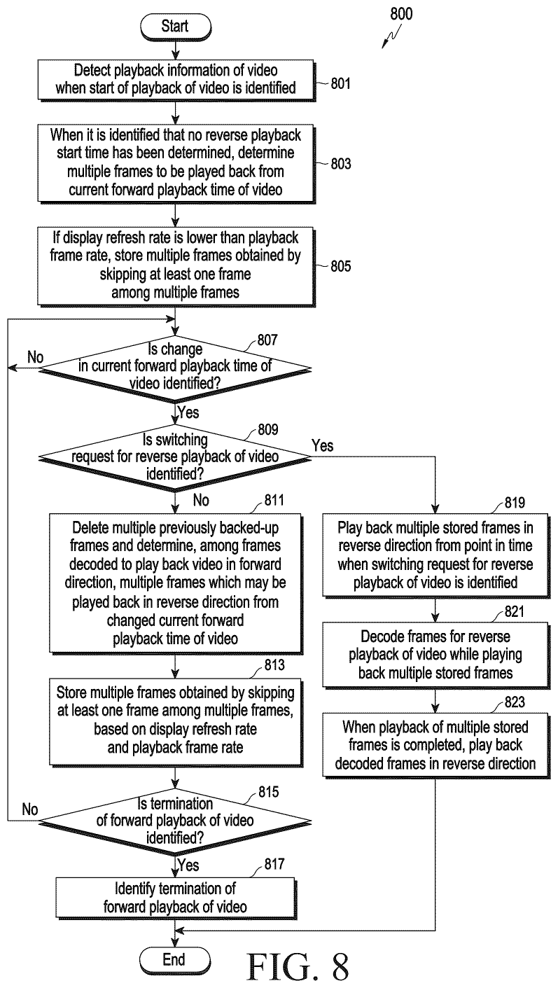

FIG. 8 is a flowchart 800 for illustrating an operation of playing back a video in reverse by an electronic device in a state where a reverse playback start time of the video is not determined, according to an embodiment of the disclosure. Operations of detecting a plurality of frames for reverse playback of the video may include operations 801 to 823. In the following embodiments, respective operations may be sequentially performed, but are not necessarily performed sequentially. For example, the order of the respective operations may be changed, at least two operations may be performed in parallel, or another operation may be added.

In operation 801, an electronic device (e.g., electronic device 101 of FIG. 1 and/or electronic device 201 of FIG. 2) may detect playback information of a video when start of playback of the video is identified.

According to an embodiment, the electronic device may identify information indicating whether the video is switchable in reverse, playback section information, and playback rate information, based on first information received from an application related to playback of the video.

In operation 803, when the electronic device (e.g., electronic device 101 of FIG. 1 and/or electronic device 201 of FIG. 2) identifies that no reverse playback start time has been determined, the electronic device may determine a plurality of frames to be played back from a current forward playback time of the video.

According to an embodiment, the electronic device may, while the video is being played back in the forward direction, determine, among frames decoded to play back the video in the forward direction, a plurality of frames to be played back from the current forward playback time of the video when the video is played back in reverse.

According to an embodiment, the electronic device may determine the plurality of frames so that, when playing back the video in reverse, a playback completion time of the stored plurality of frames from the current forward playback time of the video is longer than or equal to the time required for decoding the frames for reverse playback of the video.

According to an embodiment, by using Equation 1, the electronic device may, while the video is being played back in the forward direction, determine, among the frames decoded to play back the video in the forward direction, a plurality of frames to be played back from a point in time when a reverse switching request for the video is identified when the video is played back in reverse.

In operation 805, if a display refresh rate is lower than a playback frame rate, the electronic device (e.g., electronic device 101 of FIG. 1 and/or electronic device 201 of FIG. 2) may store a plurality of frames obtained by skipping at least one frame among the plurality of frames.

According to an embodiment, the electronic device may identify a display refresh rate value, compare the display refresh rate with a playback frame rate (playback frame rate=video fps*playback rate) value, and if a result of the comparison shows that the display refresh rate value is smaller than the playback frame rate value, the playback frame rate cannot be fully output, so that a frame skip ratio may be calculated by considering the display refresh rate. When the electronic device identifies “playback frame rate value/display refresh rate=a”, a skip ratio (frame skip ratio) of “1/a” obtained by dividing “1” by the calculation result value of “a” may be detected. The processor 220 may add the skip ratio to each of the plurality of frames determined for reverse playback of the video, and store, in memory (e.g., the memory of FIG. 2), only frames in which an integer value of a first digit is changed.

In operation 807, the electronic device (e.g., the electronic device 101 of FIG. 1 and/or the electronic device 201 of FIG. 2) may identify a change in the current forward playback time of the video, and in operation 809, if a switching request for reverse playback of the video cannot be identified, in operation 811, the electronic device may, delete the previously stored plurality of frames and determine, among the frames decoded to play back the video in forward direction, a plurality of frames capable of being played back in the reverse direction from the changed current forward playback time of the video.

In operation 813, the electronic device (e.g., electronic device 101 of FIG. 1 and/or electronic device 201 of FIG. 2) may store a plurality of frames obtained by skipping at least one frame among the plurality of frames, based on the display refresh rate and the playback frame rate.

In operation 815, if the electronic device (e.g., electronic device 101 of FIG. 1 and/or electronic device 201 of FIG. 2) is unable to identify, termination of forward playback of the video, operations 807 to 815 may be repeatedly performed.

In operation 815, if the electronic device (e.g., electronic device 101 of FIG. 1 and/or electronic device 201 of FIG. 2) identifies, termination of forward playback of the video, in operation 817, the termination of the forward playback of the video may identified.

In operation 809, when the electronic device (e.g., the electronic device 101 of FIG. 1 and/or the electronic device 201 of FIG. 2) identifies the switching request for reverse playback of the video, in operation 819, the stored a plurality of frames may be played back in the reverse direction from a point in time when the switching request for reverse playback of the video is identified.

According to an embodiment, when the switching request for reverse playback of the video is identified, the electronic device may play back the plurality of frames stored in the memory (e.g., the memory 230 of FIG. 2) in the reverse direction.

In operation 821, the electronic device (e.g., electronic device 101 of FIG. 1 and/or electronic device 201 of FIG. 2) may decode the frames for reverse playback of the video while playing back the stored a plurality of frames.

According to an embodiment, while the plurality of frames stored in the memory are being played back in the reverse direction, the electronic device may perform decoding from a first frame of the video to a frame immediately before the stored a plurality of frames.

In operation 823, the electronic device (e.g., electronic device 101 of FIG. 1 and/or electronic device 201 of FIG. 2) may play back the decoded frames in the reverse direction when the playback of the stored a plurality of frames is completed.

According to an embodiment, when the playback of the stored a plurality of frames is completed, the electronic device may play back the frames, which are decoded during the playback of the plurality of frames, in the reverse direction.

According to an embodiment, the electronic device may delete, from the memory, a frame that has been played back among the plurality of frames stored in the memory.

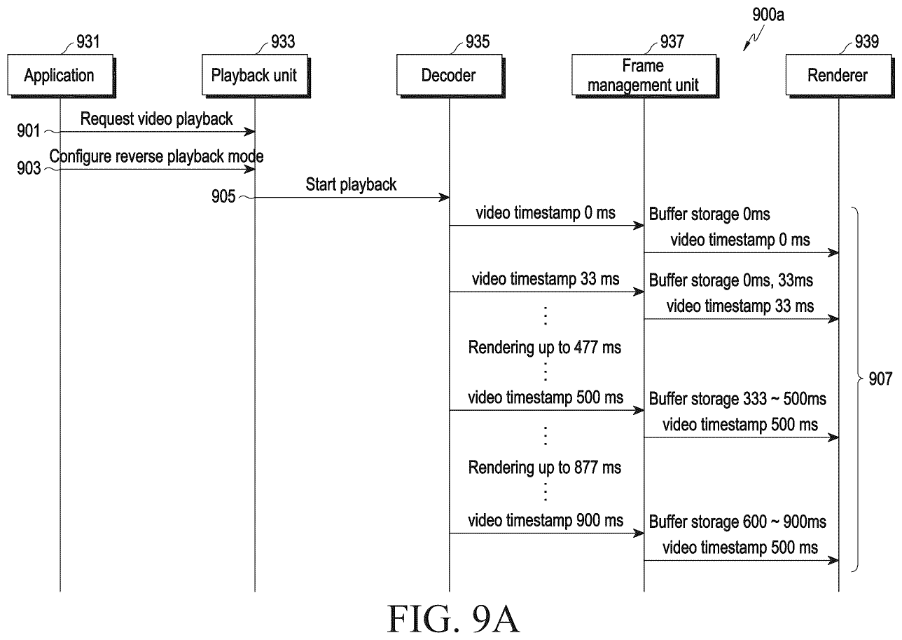

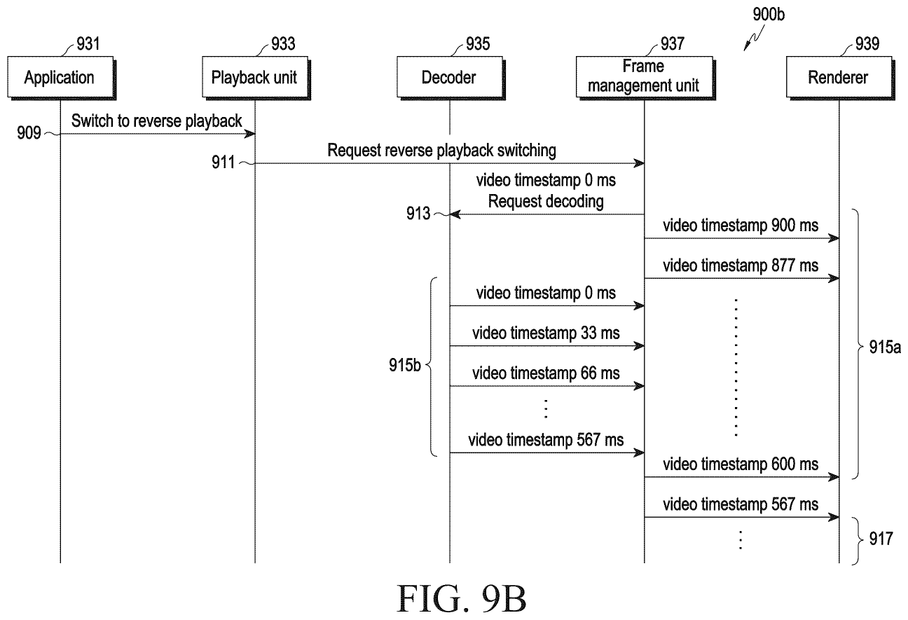

FIGS. 9A and 9B are flowcharts 900a and 900b for illustrating an operation of playing back a video in reverse by an electronic device in a state where a reverse playback start time of the video is not determined, according to various embodiments of the disclosure. Operations of playing back the video in reverse may include operations 901 to 917. In the following embodiments, respective operations may be sequentially performed, but are not necessarily performed sequentially. For example, the order of the respective operations may be changed, at least two operations may be performed in parallel, or another operation may be added. In FIGS. 9A and 9B, a playback unit and a frame management unit are described separately, but operations of the playback unit and the frame management unit may be performed in the same manner as a processor (e.g., the processor 120 of FIG. 1 and/or the processor 220 of FIG. 2).

In operation 901, a playback unit 933 of an electronic device may receive a video playback request from an application 931 related to video playback.

In operation 903, the playback unit may receive information that notifies of configuration of a reverse playback mode for a video from the application related to video playback.

In operation 905, the playback unit may request a decoder 935 (e.g., the decoder 271 of FIG. 2) of the electronic device to start forward playback of the video.

In operation 907, while the decoder 935 is transmitting decoded frames from 0 ms to 900 ms to a renderer 939 (e.g., the renderer 275 of FIG. 2) of the electronic device so as to play back the same in the forward direction, a frame management unit 937 of the electronic device may use Equation 1 to store, in memory (e.g., the memory of FIG. 2), a plurality of frames capable of being played back in the reverse direction from a current forward playback time of the video. The frame management unit 937 may delete the previously stored plurality of frames (e.g., frames from 333 ms to 500 ms) when the current forward playback time of the video is changed, and may use Equation 1 to newly store, in the memory, a plurality of frames (e.g., frames from 600 ms to 900 ms) capable of being played back in the reverse direction from the changed current forward playback time of the video.

In operation 909, the playback unit may receive a switching request for reverse playback of the video from the application 931 related to video playback.

In operation 911, the playback unit may transmit the switching request for reverse playback of the video to the frame management unit 937.

In operation 913, the frame management unit 937 may request the decoder 935 to perform decoding from a frame of 0 ms to a frame of 567 ms.

In operation 915a, in order to play back the frames from 600 ms to 900 ms, which are stored in the memory, in the reverse direction, the frame management unit 937 may transmit the stored frames from 600 ms to 900 ms to the renderer 939 in reverse order.

In operation 915b, the decoder 935 may perform decoding from the frame of 0 m to the frame of 567 ms.

In operation 915a, when the frame management unit 937 completes reverse playback of the frames from 600 ms to 900 ms, in operation 917, the decoder 935 may, in order to play back the decoded frames from 0 m to 567 ms in the reverse direction, transmit the stored frames from 0 m to 567 ms to the renderer 939 in reverse order.

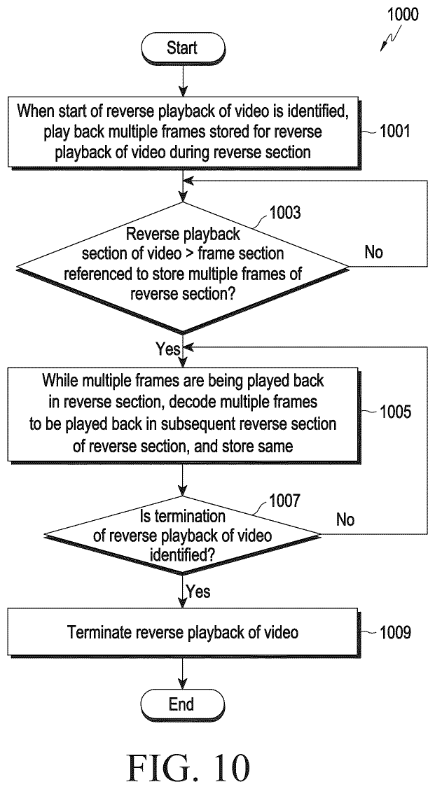

FIG. 10 is a flowchart 1000 for illustrating an operation of playing back a video in reverse by an electronic device according to an embodiment. Operations of playing back the video in reverse may include operations 1001 to 1009. In the following embodiments, respective operations may be sequentially performed, but are not necessarily performed sequentially. For example, the order of the respective operations may be changed, at least two operations may be performed in parallel, or another operation may be added.

In operation 1001, when an electronic device (e.g., the electronic device 101 of FIG. 1 and/or the electronic device 201 of FIG. 2) identifies start of reverse playback of a video, a plurality of frames stored for reverse playback of the video may be played back during a reverse section.

In operation 1003, the electronic device (e.g., the electronic device 101 of FIG. 1 and/or the electronic device 201 of FIG. 2) may compare the reverse playback section of the video with a frame section referenced to store the plurality of frames of the reverse section.

According to an embodiment, the frame section referenced to store the plurality of frames of the reverse section may indicate a frame section including a first previous 1^{st} sync frame that is closest to an end time (a frame timestamp of a reverse playback start point in a state where a reverse playback start time of the video has been determined, and a frame timestamp of a current forward playback time of the video in a state where no reverse playback start time has been determined) or a frame section including a second previous 2^{nd} sync frame that is second closest to the end time.

If, in operation 1003, the reverse playback section of the video is greater than the frame section, the electronic device (e.g., the electronic device 101 of FIG. 1 and/or the electronic device 201 of FIG. 2) may, while the plurality of frames are being played back in the reverse section, decode a plurality of frames to be played back in a subsequent reverse section of the reverse section and store the same, in operation 1005.

According to an embodiment, while playing back a plurality of frames stored when the video is played back in the forward direction in the reverse section based on Equation 1, the electronic device may identify a closest or a second closest subsequent frame section in the frame section, detect a plurality of frames to be played back in the subsequent reverse section in the subsequent frame section, decode the plurality of detected frames, and store the same in the memory (e.g., the memory 230 of FIG. 2). The electronic device may delete a plurality of frames stored in the memory, the plurality of frames having been played back in the reverse section, and may store, in the memory, a plurality of frames for the subsequent reverse playback section.

In operation 1007, if the electronic device (e.g., the electronic device 101 of FIG. 1 and/or the electronic device 201 of FIG. 2) is unable to identify termination of the reverse playback of the video, the electronic device may repeatedly perform operations 1005 and 1007, and play back the video in reverse while detecting and storing a plurality of frames to be played back in a subsequent reverse section during the playback of the stored a plurality of frames in the reverse section while the video is being played back in reverse.

in operation 1007, when termination of the reverse playback of the video is identified, in operation 1009, the electronic device (e.g., the electronic device 101 of FIG. 1 and/or the electronic device 201 of FIG. 2) may terminate the reverse playback of the video.

A method for playing back a video in reverse by an electronic device according to an embodiment may include, while a video is being played back in the forward direction, determining, among frames decoded to play back the video in the forward direction, a plurality of frames capable of being played back for a time required for decoding frames for reverse playback of the video when the video is played back in reverse.

The method according to an embodiment may include storing the plurality of determined frames in memory of the electronic device.

The method according to an embodiment may include playing back the stored plurality of frames in the reverse direction when playing back the video in reverse.

The method according to an embodiment may include, when the playback of the stored plurality of frames is completed, playing back, in the reverse direction, the frames decoded for reverse playback of the video.

The method according to an embodiment may further include determining the plurality of frames so that, when playing back the video in reverse, a reverse playback completion time of the stored plurality of frames is longer than or equal to the time required for decoding the frames for reverse playback of the video.

The method according to an embodiment may further include, if a reverse playback start time of the video has been determined, determining, among the frames decoded to play back the video in the forward direction, a plurality of frames capable of being played back in the reverse direction from the reverse playback start time of the video.

The method according to an embodiment may include detecting a first previous sync frame that is closest to the reverse playback start time of the video and a second previous sync frame that is second closest to the reverse playback start time of the video.

The method according to an embodiment may include, if a time required for decoding from the second sync frame to the first sync frame is less than a playback time from the reverse playback start time of the video to the first sync frame, determining the plurality of frames in a first frame group including the first sync frame.

The method according to an embodiment may further include, if the time required for decoding from the second sync frame to the first sync frame is greater than the playback time from the reverse playback start time of the video to the first sync frame, determining the plurality of frames in the first frame group including the first sync frame and a second frame group including the second sync frame.

The method according to an embodiment may further include, if the reverse playback start time of the video is not determined, determining, among the frames decoded to play back the video in the forward direction, a plurality of frames capable of being played back in the reverse direction from a current forward playback time of the video.

The method according to an embodiment may include detecting a first previous sync frame that is closest to the current forward playback time of the video and a second previous sync frame that is second closest to the current forward playback time of the video.

The method according to an embodiment may include, if the time required for decoding from the second sync frame to the first sync frame is less than a playback time from the current forward playback time of the video to the first sync frame, determining the plurality of frames in a first frame group including the first sync frame.

The method according to an embodiment may further include, if the time required for decoding from the second sync frame to the first sync frame is greater than the playback time from the current forward playback time of the video to the first sync frame, determining the plurality of frames in the first frame group including the first sync frame and a second frame group including the second sync frame.

The method according to an embodiment may include storing the plurality of determined frames in the memory.

The method according to an embodiment may include, when the current forward playback time of the video is changed, deleting the plurality of frames stored in the memory.

The method according to an embodiment may further include determining a plurality of frames to be stored in the memory, based on the changed current forward playback time of the video.

The method according to an embodiment may further include, if a display refresh rate is lower than a playback frame rate, storing, in the memory, a plurality of frames obtained by skipping at least one frame based on the display refresh rate from among the plurality of determined frames.

The method according to an embodiment may further include, if a video resolution is higher than a display resolution, resizing resolutions of the plurality of determined frames to the display resolution, and then storing the same in the memory.

The method according to an embodiment may further include deleting, from the memory, a frame that has been played back among the stored plurality of frames.

In a non-transitory storage medium storing instructions according to an embodiment of the disclosure, the instructions are configured to, when executed by an electronic device, cause the electronic device to perform at least one operation including, while a video is being played back in the forward direction, determining, among frames decoded to play back the video in the forward direction, a plurality of frames capable of being played back for a time required for decoding frames for reverse playback of the video when the video is played back in reverse, storing the plurality of determined frames in memory of the electronic device, playing back the stored plurality of frames in the reverse direction when playing back the video in reverse, and when the playback of the stored plurality of frames is completed, playing back, in the reverse direction, the frames decoded for reverse playback of the video.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101 or the electronic device 301). For example, a processor (e.g., the processor 520) of the machine (e.g., the electronic device 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
at least one processor; and
memory, comprising one or more storage media, storing instructions that, when executed by the at least one processor individually or collectively, cause the electronic device to:
while a video is being played back in a forward direction, determine, among frames decoded to play back the video in the forward direction, a plurality of frames capable of being played back for a time required for decoding frames for reverse playback of the video in case that the video is played back in reverse,
store the plurality of determined frames in the memory,
in case that the video is played back in reverse, play back the stored plurality of frames in a reverse direction, and
in case that the playback of the stored plurality of frames is completed, play back, in the reverse direction, the frames decoded for reverse playback of the video.

2. The electronic device of claim 1, wherein the instructions, when executed by the at least one processor individually or collectively, cause the electronic device to:
determine the plurality of frames such that, in case that the video is played back in reverse, a reverse playback completion time of the stored plurality of frames is longer than or equal to the time required for decoding the frames for reverse playback of the video.

3. The electronic device of claim 1, wherein the instructions, when executed by the at least one processor individually or collectively, cause the electronic device to:
in case that a reverse playback start time of the video has been determined, determine, among the frames decoded to play back the video in the forward direction, a plurality of frames capable of being played back in the reverse direction from the reverse playback start time of the video.

4. The electronic device of claim 3, wherein the instructions, when executed by the at least one processor individually or collectively, cause the electronic device to:
detect a first previous sync frame that is closest to the reverse playback start time of the video and a second previous sync frame that is second closest to the reverse playback start time of the video,
in case that a time required for decoding from the second previous sync frame to the first previous sync frame is less than a playback time from the reverse playback start time of the video to the first previous sync frame, determine the plurality of frames in a first frame group comprising the first previous sync frame, and
in case that the time required for decoding from the second previous sync frame to the first previous sync frame is greater than the playback time from the reverse playback start time of the video to the first previous sync frame, determine the plurality of frames in the first frame group comprising the first previous sync frame and a second frame group comprising the second previous sync frame.

5. The electronic device of claim 1, wherein the instructions, when executed by the at least one processor individually or collectively, cause the electronic device to:
in case that no reverse playback start time of the video has been determined, determine, among the frames decoded to play back the video in the forward direction, a plurality of frames allowed to be played back in the reverse direction from a current forward playback time of the video.

6. The electronic device of claim 5, wherein the instructions, when executed by the at least one processor individually or collectively, cause the electronic device to:
detect a first previous sync frame that is closest to the current forward playback time of the video and a second previous sync frame that is second closest to the current forward playback time of the video,
in case that a time required for decoding from the second previous sync frame to the first previous sync frame is less than a playback time from the current forward playback time of the video to the first previous sync frame, determine the plurality of frames in a first frame group comprising the first previous sync frame, and
in case that the time required for decoding from the second previous sync frame to the first previous sync frame is greater than the playback time from the current forward playback time of the video to the first previous sync frame, determine the plurality of frames in the first frame group comprising the first s previous ync frame and a second frame group comprising the second previous sync frame.

7. The electronic device of claim 5, wherein the instructions, when executed by the at least one processor individually or collectively, cause the electronic device to:
store the plurality of determined frames in the memory;
in case that the current forward playback time of the video is changed, delete the plurality of frames stored in the memory; and
determine a plurality of frames to be stored in the memory, based on the changed current forward playback time of the video.

8. The electronic device of claim 1, wherein the instructions, when executed by the at least one processor individually or collectively, cause the electronic device to:
in case that a display refresh rate is lower than a playback frame rate, store, in the memory, a plurality of frames obtained by skipping at least one frame based on the display refresh rate from among the plurality of determined frames.

9. The electronic device of claim 1, wherein the instructions, when executed by the at least one processor individually or collectively, cause the electronic device to:
in case that a video resolution is higher than a display resolution, resize resolutions of the plurality of determined frames to the display resolution, and then store the same in the memory.

10. The electronic device of claim 1, wherein the instructions, when executed by the at least one processor individually or collectively, cause the electronic device to:
delete, from the memory, a frame that has been played back among the stored plurality of frames.

11. A method for playing back a video in reverse performed by an electronic device, the method comprising:
while a video is being played back in a forward direction, determining, among frames decoded to play back the video in the forward direction, a plurality of frames capable of being played back for a time required for decoding frames for reverse playback of the video in case that the video is played back in reverse;
storing the plurality of determined frames in memory of the electronic device;
in case that the video is played back in reverse, playing back the stored plurality of frames in a reverse direction; and
in case that the playback of the stored plurality of frames is completed, playing back, in the reverse direction, the frames decoded for reverse playback of the video.

12. The method of claim 11, further comprising:
determining the plurality of frames so that, in case that the video is played back in reverse, a reverse playback completion time of the stored plurality of frames is longer than or equal to the time required for decoding the frames for reverse playback of the video.

13. The method of claim 11, further comprising:
in case that a reverse playback start time of the video has been determined, determining, among the frames decoded to play back the video in the forward direction, a plurality of frames capable of being played back in the reverse direction from the reverse playback start time of the video.

14. The method of claim 13, further comprising:
detecting a first previous sync frame that is closest to the reverse playback start time of the video and a second previous sync frame that is second closest to the reverse playback start time of the video;
in case that a time required for decoding from the second previous sync frame to the first previous sync frame is less than a playback time from the reverse playback start time of the video to the first previous sync frame, determining the plurality of frames in a first frame group comprising the first previous sync frame; and
in case that the time required for decoding from the second previous sync frame to the first previous sync frame is greater than the playback time from the reverse playback start time of the video to the first previous sync frame, determining the plurality of frames in the first frame group comprising the first previous sync frame and a second frame group comprising the second previous sync frame.

15. The method of claim 11, further comprising:
in case that no reverse playback start time of the video has been determined, determining, among the frames decoded to play back the video in the forward direction, a plurality of frames allowed to be played back in the reverse direction from a current forward playback time of the video.

16. The method of claim 15, further comprising:
detecting a first previous sync frame that is closest to the current forward playback time of the video and a second previous sync frame that is second closest to the current forward playback time of the video;
in case that a time required for decoding from the second previous sync frame to the first previous sync frame is less than a playback time from the current forward playback time of the video to the first previous sync frame, determining the plurality of frames in a first frame group comprising the first previous sync frame; and
in case that the time required for decoding from the second previous sync frame to the first previous sync frame is greater than the playback time from the current forward playback time of the video to the first previous sync frame, determining the plurality of frames in the first frame group comprising the first previous sync frame and a second frame group comprising the second previous sync frame.

17. The method of claim 15, further comprising:
storing the plurality of determined frames in the memory;
in case that the current forward playback time of the video is changed, deleting the plurality of frames stored in the memory; and
determining a plurality of frames to be stored in the memory, based on the changed current forward playback time of the video.

18. The method of claim 11, further comprising:
in case that a display refresh rate is lower than a playback frame rate, storing, in the memory, a plurality of frames obtained by skipping at least one frame based on the display refresh rate from among the plurality of determined frames.

19. The method of claim 11, further comprising:
in case that a video resolution is higher than a display resolution, resizing resolutions of the plurality of determined frames to the display resolution, and then store the same in the memory.

20. One or more non-transitory storage media storing one or more computer programs including computer-executable instructions that, when executed by one or more processors of an electronic device individually or collectively, cause the electronic device to perform operations, the operations comprising:
while a video is being played back in a forward direction, determining, among frames decoded to play back the video in the forward direction, a plurality of frames capable of being played back for a time required for decoding frames for reverse playback of the video in case that the video is played back in reverse;
storing the plurality of determined frames in memory of the electronic device;
in case that the video is played back in reverse, playing back the stored plurality of frames in a reverse direction; and
in case that the playback of the stored plurality of frames is completed, playing back, in the reverse direction, the frames decoded for reverse playback of the video.
